(19) United States
(12) Patent Application Publication
(10) Pub. No.: US 2008/0302304 A1
(43) Pub. Date: Dec. 11, 2008

(54) BIRD FEED COLLECTOR

(76) Inventor: James S. Mayfield, Rock Hill, SC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/760,130

(22) Filed: Jun. 8, 2007

(51) Int. Cl. A01K 39/01

(52) U.S. Cl. 119/51.01

(57) ABSTRACT

A feed collector for collecting fallen seed under a bird feeder of the type maintained above the ground by a vertical support. The collector includes an upwardly extending outer wall, an interior surface, and a plurality of removal portions defining portions of the collector for removal to provide an opening for receiving the vertical support. The removal portions can include one or more marks, perforations and/or weakened areas.

### TECHNICAL FIELD AND BACKGROUND OF THE INVENTION

This invention relates to a feed collector for collecting fallen seed under a bird feeder of the type maintained above the ground by a vertical support, a bird feeder including the collector, and a method of installing a bird feeder.

It is often desirable to collect fallen seed and droppings below a bird feeder to prevent the fallen seeds from sprouting and thus maintaining a yard in an area below the feeder. Thus, there is a need for a bird feed collector for use with feeders of the type maintained above a substrate such as the ground by a vertical support. The feed collector should be cost effective to manufacture yet versatile inasmuch as it should provide a user with a plurality of removable portions for adapting the collector to use with a range of existing feeders.

### SUMMARY OF THE DISCLOSURE

Therefore, it is an object of the invention to provide a bird feed collector for use with feeders of the type maintained above a substrate by a support.

It is another object to provide a bird feed collector that can be adapted for use with a variety of existing bird feeders.

These and other objects of the present invention are achieved in the preferred embodiments disclosed below by providing a feed collector for collecting fallen seed under a bird feeder of the type maintained above the ground by a vertical support. The collector includes an upwardly extending outer wall, an interior surface, and a plurality of marks, perforations, weakened areas or combinations thereof defining portions of the collector for removal to provide an opening for receiving the vertical support.

According to another preferred embodiment of the invention, the outer wall includes a circular top edge.

According to another preferred embodiment of the invention, the portions defined by the marks, perforations, weakened areas or combinations thereof are circular.

According to another preferred embodiment of the invention, the circular portions are concentric.

According to another preferred embodiment of the invention, at least one portion takes the shape of a quadrilateral.

According to another preferred embodiment of the invention, the quadrilateral is square.

According to another preferred embodiment of the invention, the upwardly extending wall has a concave inner surface.

According to another preferred embodiment of the invention, a bird feeder includes a feed dispensing container, a support for maintaining the container above the ground, and a seed collector for placement on the ground under the container to collect fallen seed. The collector includes a plurality of marks, perforations, weakened areas or combinations thereof defining portions for removal to provide an opening for receiving the support.

According to another preferred embodiment of the invention, the support is a post or pole.

According to another preferred embodiment of the invention, a method of installing a bird feeder includes providing a bird seed collector having an upwardly extending outer wall, an interior surface and a plurality of marks, perforations, weakened areas or combinations thereof defining portions of the collector for removal to provide an opening for receiving a vertical support. The method further includes providing a feed dispensing container and a support for maintaining the feeder above the ground. Also, the method includes removing one or more of the portions defined by the marks, perforations, weakened areas or combinations thereof to provide an opening, inserting an end of the support in the opening, and securing the support in position to extend upwardly for maintaining the container on the support.

### BRIEF DESCRIPTION OF THE DRAWINGS

Embodiments of the invention may be best understood by reference to the following description in conjunction with the accompanying drawing figures in which:

FIG. 1 is a perspective view of a bird feed collector;

FIG. 2 is a side view of the bird feed collector;

FIG. 3 is a top view of the bird feed collector; and

FIG. 4 is a side perspective view of a bird feeder including the bird feed collector.

### DESCRIPTION OF EMBODIMENTS OF THE INVENTION

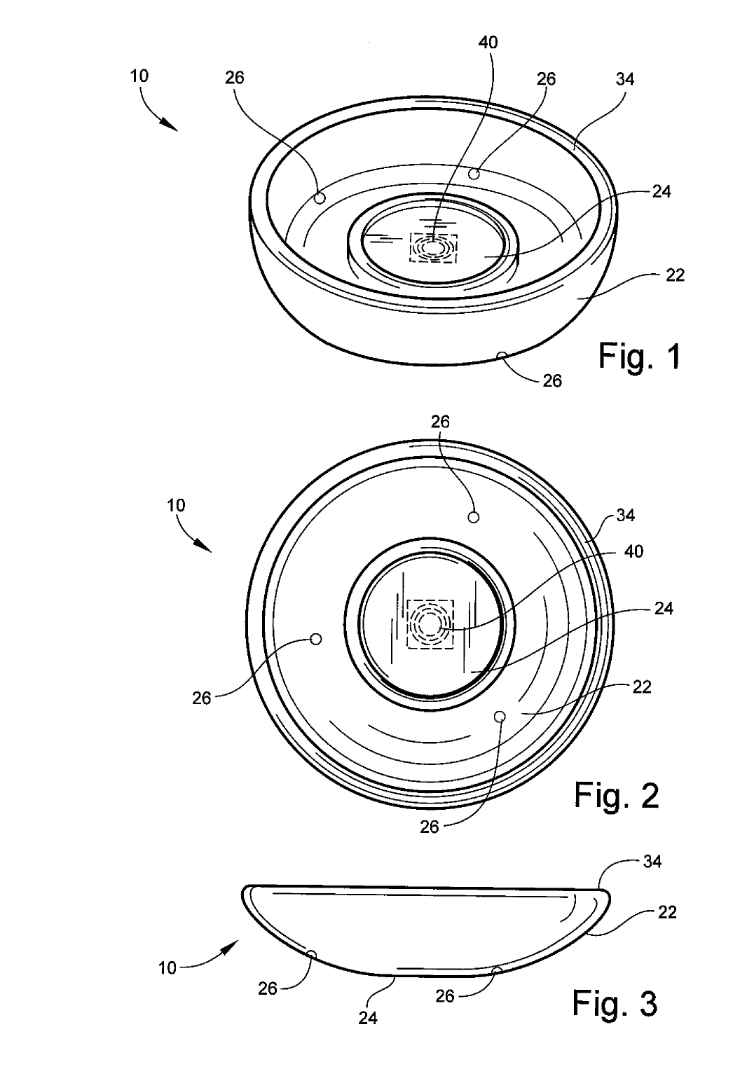

In an embodiment of the invention shown in FIGS. 1-3, a bird feed collector 10 for collecting fallen seed under a bird feeder of the type maintained above the ground by a vertical support, the feeder includes an upwardly extending outer wall 22 coupled to an interior collector surface 24. The collector 10 shown is generally bowl or dish-shaped and the upwardly extending wall is concave and has a circular top edge 34. A plurality of marks, perforations, weakened areas or combinations thereof 40 define portions of the collector 10 that can be removed by, for example, punching or cutting them out to provide an opening for receiving the vertical support. The marks, perforations, weakened areas or combinations thereof 40 may form concentric circles in the interior of the collector 10 such that the openings provided when one or more of the circular portions 52 are removed are sized to receive relatively snugly a post or pole with a circular cross section. In addition, one or more may be in the shape of a square for receiving, for example, a four by four, and a plurality of various sized squares can also be provided in concentric disposition.

As shown in FIGS. 1-4, the bird feed collector 10 includes a plurality of drainage holes 26 along the perimeter of the outer wall 22 of the collector 10. The drainage holes can be indicated by indicating means such as a mark or thin area so that they can be cut out by the user, if desired.

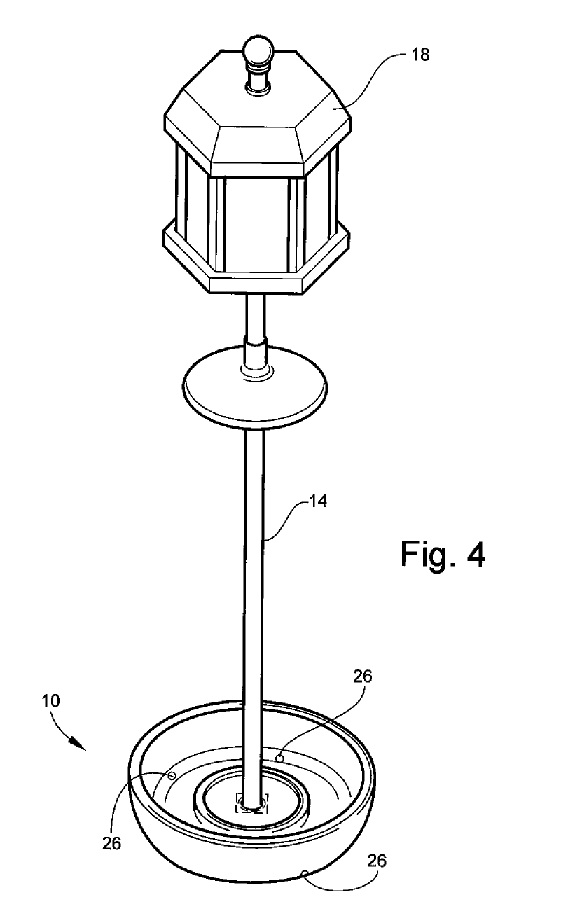

FIG. 4 shows the seed collector 10 in combination with a vertical support 14, such as a post or pole, maintaining a feed dispensing container 18 above the seed collector 10. The feed dispensing container 18 typically includes a housing having a top opening for receiving bird feed and a plurality of smaller opening at a ledge below.

A method of installing a bird feeder includes removing one or more of the portions defined by the marks, perforations, weakened areas or combinations thereof 40 to provide an opening and inserting an end of the support through the opening in the collector. The support can be secured in an upwardly extending disposition with respect to a substrate, typically by burying an end distal the support in the ground with the seed collector 10 resting on the ground surrounding the support 14.

A bird seed collector, bird feeder including the collector, and a method of installing the bird feeder are herein described. Various details of the inventions may be changed without departing from their scope. Furthermore, the foregoing description of the preferred embodiments of the invention and best mode for practicing the invention are provided for the purpose of illustration only and not for the purpose of limitation.

I claim:

1. A feed collector for collecting fallen seed under a bird feeder of the type maintained above the ground by a vertical support, the collector comprising:
(a) an upwardly extending outer wall;
(b) an interior surface; and
(c) a plurality of removal portions defining portions of the collector for removal to provide an opening for receiving the vertical support, wherein the removal portions comprise one or more selected from the group consisting of marks, perforations and weakened areas.

2. A feed collector according to claim 1, wherein the outer wall comprises a circular top edge.

3. A feed collector according to claim 1, wherein the removal portions are circular.

4. A collector according to claim 3, wherein the removal portions are concentric.

5. A collector according to claim 1, wherein at least one removal portion has the shape of a quadrilateral.

6. A collector according to claim 5, wherein the at least one removal portion is square.

7. A collector according to claim 1, wherein the upwardly extending wall has a concave inner surface.

8. A collector according to claim 1, further comprising at least one drainage opening for draining liquid from the collector.

9. A collector according to claim 8, further comprising indicating means proximate the at least one drainage opening for indicating to the user the location of the drainage opening.

10. A collector according to claim 1, further comprising a plurality of drainage openings formed in the outer wall of the collector.

11. A collector according to claim 1, further comprising indicating means proximate the plurality of drainage openings for indicating to the user the location of the drainage openings.

12. A collector according to claim 1, wherein the plurality of removal portions are formed in the interior surface.

13. A bird feeder, comprising:
(a) a feed dispensing container;
(b) a support for maintaining the container above the ground; and
(c) a seed collector for placement on the ground under the container to collect fallen seed, the collector comprising a plurality of removal portions defining portions of the collector for removal to provide an opening for receiving the vertical support.

14. A bird feeder according to claim 13, wherein the support is selected from the group consisting of a post and a pole.

15. A bird feeder according to claim 13, wherein the removal portions comprise one or more selected from the group consisting of marks, perforations and weakened areas.

16. A bird feeder according to claim 13, wherein the seed collector comprises an interior surface connected to an upwardly extending outer wall, and wherein the removal portions are formed in the interior surface.

17. A method of installing a bird feeder comprising the steps of:
(a) providing a bird seed collector having an upwardly extending outer wall, an interior surface and a plurality of removal portions defining portions of the collector for removal to provide an opening for receiving the vertical support,
(b) providing a feed dispensing container;
(c) providing a support for maintaining the feeder above the ground;
(d) removing one or more of the removal portions to provide an opening;
(e) inserting an end of the support in the opening; and
(f) securing the support in position to extend upwardly for maintaining the container on the support.

18. A method according to claim 15, wherein the removal portions comprise one or more selected from the group consisting of marks, perforations and weakened areas.
